(19) United States
(12) Patent Application Publication
(10) Pub. No.: US 2013/0332310 A1
(43) Pub. Date: Dec. 12, 2013

(54) BILLING IMPACT NOTIFICATION

(71) Applicants: Stephen Michael Danton, Seattle, WA (US); Jonah B. Sterling, Seattle, WA (US); Jesse David Francisco, Lake Stevens, WA (US); Adam Mohamed Abdelhamed, Bellevue, WA (US); Chandrika G. Shankarnarayan, Seattle, WA (US)

(72) Inventors: Stephen Michael Danton, Seattle, WA (US); Jonah B. Sterling, Seattle, WA (US); Jesse David Francisco, Lake Stevens, WA (US); Adam Mohamed Abdelhamed, Bellevue, WA (US); Chandrika G. Shankarnarayan, Seattle, WA (US)

(73) Assignee: Microsoft Corporation, Redmond, WA (US)

(21) Appl. No.: 13/602,044

(22) Filed: Aug. 31, 2012

Related U.S. Application Data
(60) Provisional application No. 61/656,349, filed on Jun. 6, 2012.

(51) Int. Cl. G06Q 30/00

(52) U.S. Cl. 705/26.8

(57) ABSTRACT

A user interface in which a control is presented in which a user may edit the control in a manner that if the edit is finalized, a bill would be affected. The user interface also displays a billing impact element that displays an effect on the bill should the edit be finalized. For instance, as edits are made to the control, corresponding effects are illustrated in the billing impact element in real-time. Thus, the user can see more immediately an impact of billing in response to possible edits, rather than wait until final payment before seeing the effect on the bill of all prior edits.

### CROSS-REFERENCE TO RELATED APPLICATIONS

The present application claims priority under 35 U.S.C. 119(e) to U.S. provisional application Ser. No. 61/656,349 filed Jun. 6, 2012, which provisional patent application is incorporated herein by reference in its entirety.

### BACKGROUND

The Internet has become a medium for commercial activity such as the purchase of products and services. In a typical user experience, a user navigates to a web site, reviews products and services, and selects one or more items for purchase, which conceptually places the items for potential purchase in an electronic shopping cart. After the user has selected the desired items by placing each item in the electronic shopping cart, a payment interface is presented in which the user is given the opportunity to review their shopping cart purchases along with the anticipated bill if the user were to finalize the purchase. If the bill is not as expected, the user may make any desired changes by returning to editing the shopping cart contents. This process is repeated until either the user cancels the purchase, or makes payment.

### BRIEF SUMMARY

At least one embodiment described herein relates to a user interface in which a control is presented in which a user may edit the control in a manner that if the edit is finalized, a bill would be affected. The user interface also displays a billing impact element that displays an effect on the bill should the edit be finalized. For instance, as edits are made to the control, corresponding effects are illustrated in the billing impact element in real-time. Thus, the user can see more immediately an impact of billing in response to possible edits, rather than wait until final payment before seeing the effect on the bill of all prior edits. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system in which some embodiments described herein may be employed;

FIG. 2 abstractly illustrates a user interface that includes a sequence of user interface contexts, each comprising simultaneously displayed user interface elements;

FIG. 3 abstractly illustrate a user interface context that may be any of the user interface contexts in the user interface of FIG. 2;

FIG. 4 abstractly illustrates a user interface context that is a specific example of the user interface context of FIG. 3;

FIG. 5 illustrates a user interface context that is a specific example of the user interface context of FIG. 3, and which includes three bill impacting controls;

FIG. 6 illustrates the user interface context of FIG. 5, except with three billing impact elements being displayed;

FIG. 7 illustrates the user interface context of FIG. 6, in which there is a mechanism for emphasizing one of the billing impact elements with respect to the rest;

FIG. 8 illustrates a user interface context that is another specific example of the user interface context of FIG. 3, and which includes bill impacting controls, but no billing impact elements;

FIG. 9 illustrates the user interface context of FIG. 8, but with billing impact elements displayed in response to editing of a billing impact control; and

FIG. 10 illustrates a flowchart of a method for providing a user interface context within a user interface.

### DETAILED DESCRIPTION

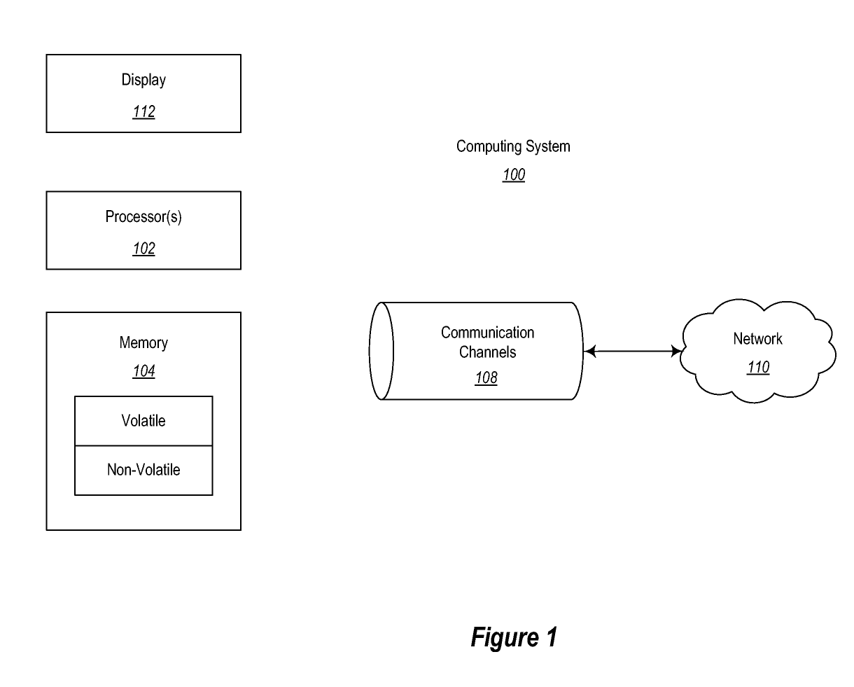

In accordance with embodiments described herein, various user interfaces are described. Such user interfaces have various advantages as will be described herein, and may be implemented on a display 112 of the computing system 100 of FIG. 1. Accordingly, some introductory discussion of a computing system will be described with respect to FIG. 1. Then, embodiments of the user interface will be described with respect to subsequent figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 may also have a display (such as display 112) on which user interfaces, such as the user interface described herein, may be visualized to a user.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

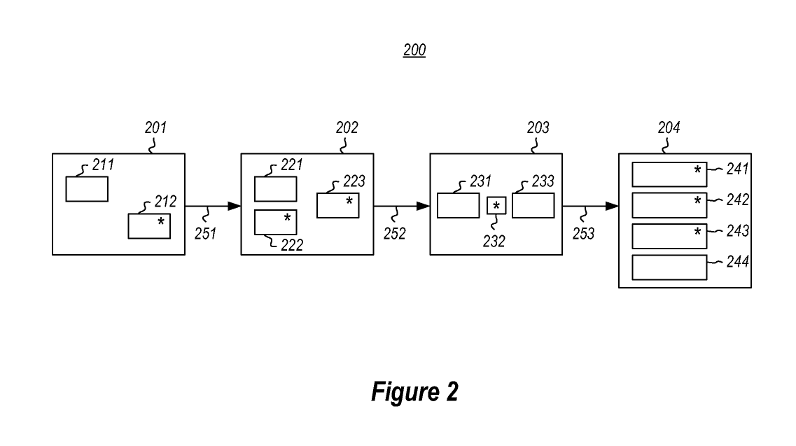

FIG. 2 illustrates a user interface 200. In this description and in the claims, a user interface comprises one or more user interface contexts. Such user interface contexts may be displayed at the same time, sequentially, or in any other manner. A user interface context comprises a set of user interface elements that are displayed at the same time. Such user interface elements may be user interface output elements in which information is displayed and/or user interface elements (also called a “user interface control”) in which a user may interact with the user interface control.

In the example user interface 200 of FIG. 2, there are four user interface contexts 201 through 204 that would be displayed to the user one at a time. The user interface 200 is provided as an example only.

As the user interacts with the user interface 200, they might first encounter a first user interface context 201. In this example, the user interface context 201 contains two user interface elements 211 and 212. In this abstract representation of user interface 200, the user interface elements that allow input (e.g., are user interface controls) are represented with an asterisk. Thus, user interface element 211 is not a control, whereas user interface element 212 is a control. Upon occurrence of a transition event, such as the passage of time or the user interfacing with a control such as control 212, the user interface 200 transitions (as represented by arrow 251) to a second user interface context 202.

The second user interface context 202 includes user interface elements 221 through 223, some of which being controls (e.g., user interface controls 222 and 223). Again, upon occurrence of a transition event, the user interface 200 transitions (as represented by arrow 252) to a third user interface context. The third user interface context 203 includes user interface elements 231 through 233, one of which being a control (e.g., user interface controls 232). Upon occurrence of a transition event, the user interface 200 transitions (as represented by arrow 253) to a final user interface context 204.

Now suppose that the user interface 200 were a shopping user interface. The preliminary user interface contexts 201, 202 and 203 may involve the user selecting items for purchase and insertion into the electronic shopping cart. The final user interface context 204 may in that case be a payment user interface context. For instance, the final interface context may be a payment user interface context that includes user interface elements 241 through 244. One of the user interface elements 244 displays the bill associated with the shopping experience. Others of the user interface elements 241 through 243 may be used to finalize payment.

The user interface 200 of FIG. 2 illustrates the principles that the preliminary user interface contexts prior to the payment user interface context often do not include any information regarding the billing impact of the user's selection. Other times, there might be a total shown in one part of the user interface that is updated, but with it being rather difficult to ascertain the effect of each selection on the overall total.

Classic approaches to billing information see the user exposed to a price sheet at the end of their shopping experience, for instance as a billing summary at the end of buying a book. The experience described herein exposes billing information throughout the user's experience. That means that regardless of the context or user interface control, a consistent billing feedback experience is delivered.

As noted above, billing information is surfaced based on the context the user is operating in. Each editing context that could impact billing is given a special treatment of the billing information to the UI control presentation that dovetails with their current experience. However, the format of the billing impact information is maintained to ensure a learn-once experience.

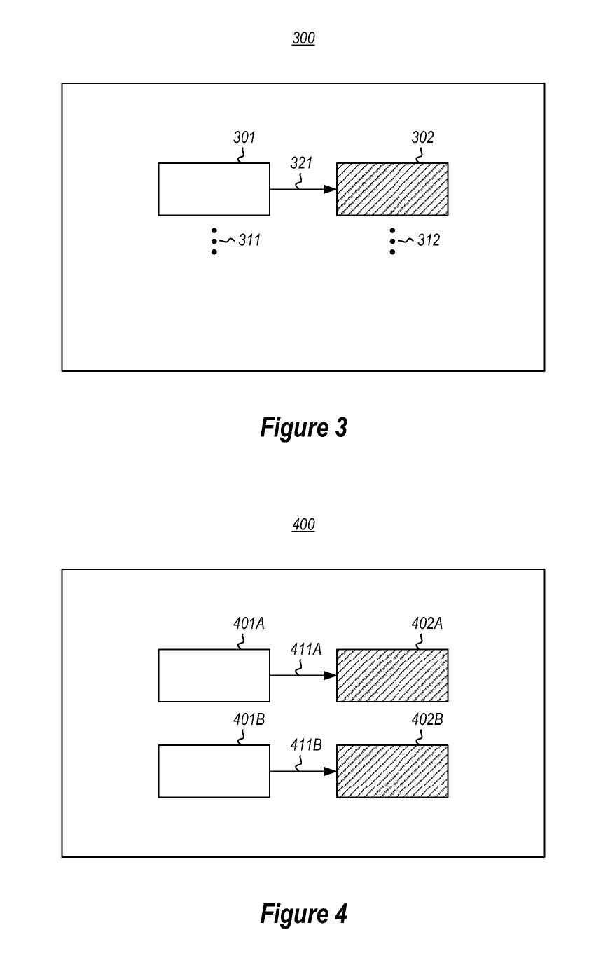

FIG. 3 abstractly illustrates a user interface context 300 that may be a specific example of any one of the user interface context 201 through 203 of FIG. 2. The user interface includes a bill impacting control 301 that if edited and finalized has an impact on a bill. For instance, the editing of the bill impacting control 301 (if finalized) may have an effect on the user's payment amount. The user interface context 300 also includes a billing impact element 302 that is responsive (as represented by arrow 321) to editing of the bill impacting control 301 to visualize a change in the bill that would result from the editing if finalized.

The billing impact elements are abstractly represented in FIGS. 3 and 4 using right leaning cross hatching. The billing impact element 302 is displayed in the user interface context 300 for at least a time after the editing occurs. For instance, the billing impact element 302 may be displayed until perhaps the user interface context 300 changes to another context, or perhaps the billing impact element 302 is displayed for a predetermined period of time. However, the principles described herein are not limited to the amount of time or conditions under which the billing impact element 302 is displayed.

The billing impact element 302 responds to any further changes in the bill impacting control 301. Such response may even be in real-time. Thus, the user can perform scenario testing even before the payment user interface context to evaluate the effect that certain choices will have on the bill.

The ellipses 311 represent that there may be more than one bill impacting control in the user interface context 300. Ellipses 312 represent that there may be more than one billing impact element in the user interface context. A bill impacting control may be mapped to a billing impact element in a one to one relationship as illustrated by the arrow 321 of FIG. 3. Alternatively, a bill impacting control may be mapped to multiple billing impact elements such that edits within the single bill impacting control may affect the visualization in multiple billing impact elements. Alternatively, multiple bill impacting controls may be mapped to a single billing impact element such that at least some possible edits within any of the bill impacting controls affect a visualization in the billing impact element.

FIG. 4 illustrates a user interface context 400 that is a specific example of the user interface context 300 of FIG. 3. The user interface context 400 includes a bill impacting control 401A that if edited and finalized has an impact on a bill, and a billing impact element 402A that is responsive (as represented by arrow 411A) to editing of the bill impacting control 401A. Thus, the billing impact element 402A visualizes a change in the bill that would result from the editing (if finalized) of the bill impacting control 401A. The user interface context 400 also includes a bill impacting control 401B that if edited and finalized has an impact on a bill, and a billing impact element 402B that is responsive (as represented by arrow 411B) to editing of the bill impacting control 401A. Thus, the billing impact element 402B visualizes a change in the bill that would result from the editing (if finalized) of the bill impacting control 401B.

FIG. 4 illustrates a one-to-one mapping between the bill impacting control and the billing impact element. In a case in which multiple bill impacting controls are mapped to a single billing impact element, the elements 402A and 402B could be conceptualized as a single billing impact element. In a case in which a single bill impacting control is mapped to multiple billing impact elements, the controls 401A and 401B could be conceptualized as a single bill impacting control.

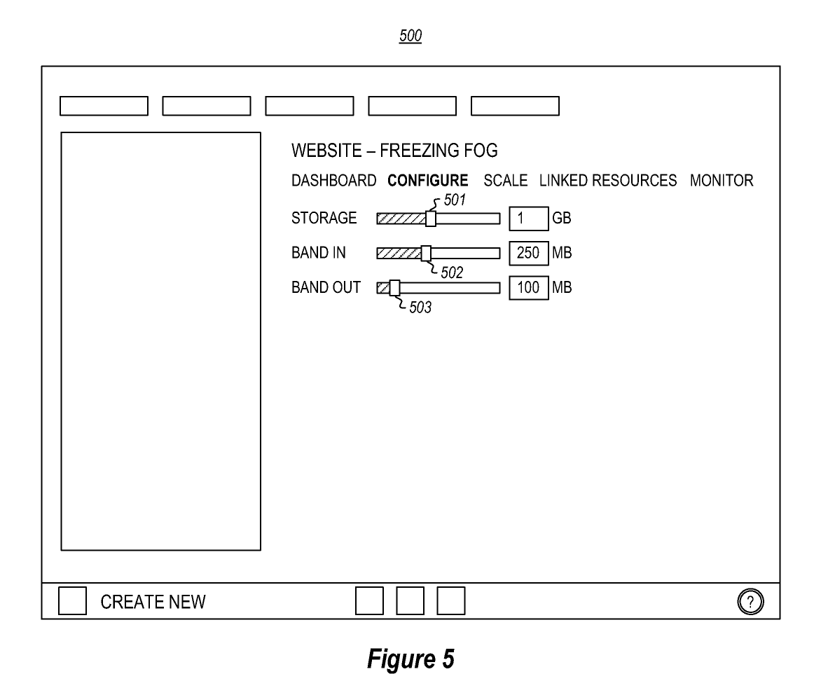

FIGS. 5 through 7 illustrates an example user interface comprises three user interface contexts. The user interface of FIGS. 5 through 7 is an example of the user interface 200 of FIG. 2. The user interface of FIGS. 5 through 7 will be referred to hereinafter as a “first example user interface”.

FIG. 5 illustrates a first user interface context 500 of the first example user interface. The first user interface context 500 includes three bill impacting controls 501, 502 and 503. In this case, the bill impacting controls 501, 502 and 503 adjust an amount of resources available for a network service. For instance, bill impacting control 501 adjusts an amount of storage available for the network service. Another example of resources is the amount of bandwidth available for the network service. For instance, bill impacting control 502 adjusts an amount of input bandwidth available for the network service, and bill impacting control 503 adjusts an amount of output bandwidth available for the network service. The network service might be, as examples, a virtual machine service in which a virtual machine is provided to the user, a web site hosting service, or any other network service. That said, the principles described herein are not limited to any particular product or service being shopped for.

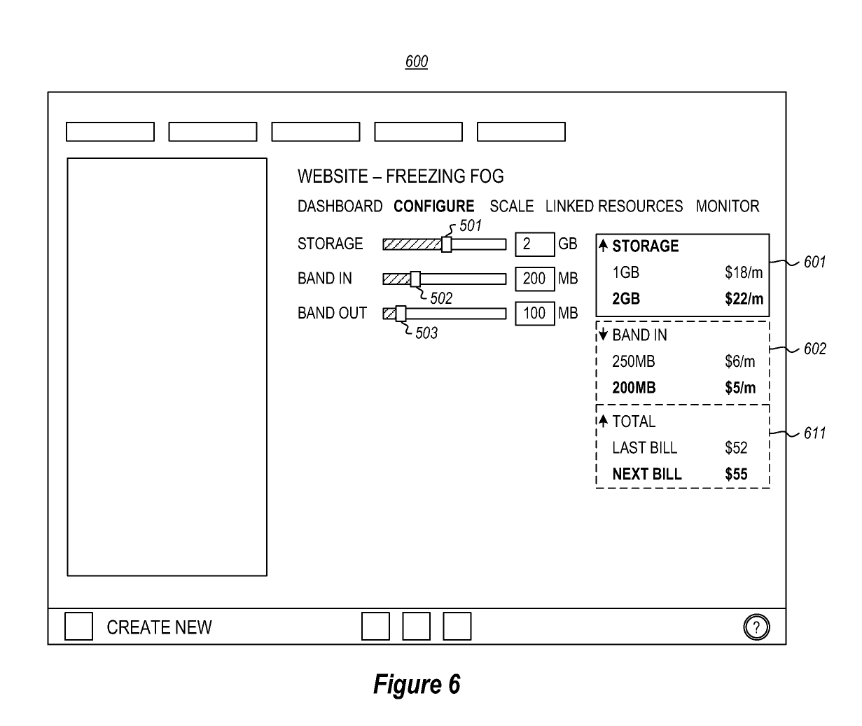

FIG. 6 illustrates a user interface context 600, which is similar to the user interface context 500, but with the addition of billing impact elements 601 and 602, corresponding to respective bill impacting controls 501 and 502, and with the addition of billing impact element 611. The corresponding billing impact element first appears when a first edit of a bill impacting control occurs. The visualized effect on the bill is illustrated in the corresponding billing impact element.

For instance, comparing FIGS. 5 and 6, the user adjusted the bill impacting control 501 to adjust the amount of storage for a web site hosting service from 1 gigabyte to 2 gigabytes. As reflected in billing impact element 601, the result was an increase in the line item for storage from 18 dollars a month to 25 dollars per month. Furthermore, the user adjusted the bill impacting control 502 to adjust the amount of input bandwidth available for the web site hosting service from 250 megabytes per second to 200 megabytes per second. As reflected in billing impact element 602, the result was a decrease in the line item for input bandwidth from 6 dollars per month to 5 dollars per month. A total portion 611 shows an effect of the total bill. Thus, in this case, the bill impacting controls 501 and 502 have a one-to-one mapping to corresponding line item billing impact elements 601 and 602, respectively. At the same time, the bill impacting controls 501 and 502 are both mapped to a single total billing impact element 611.

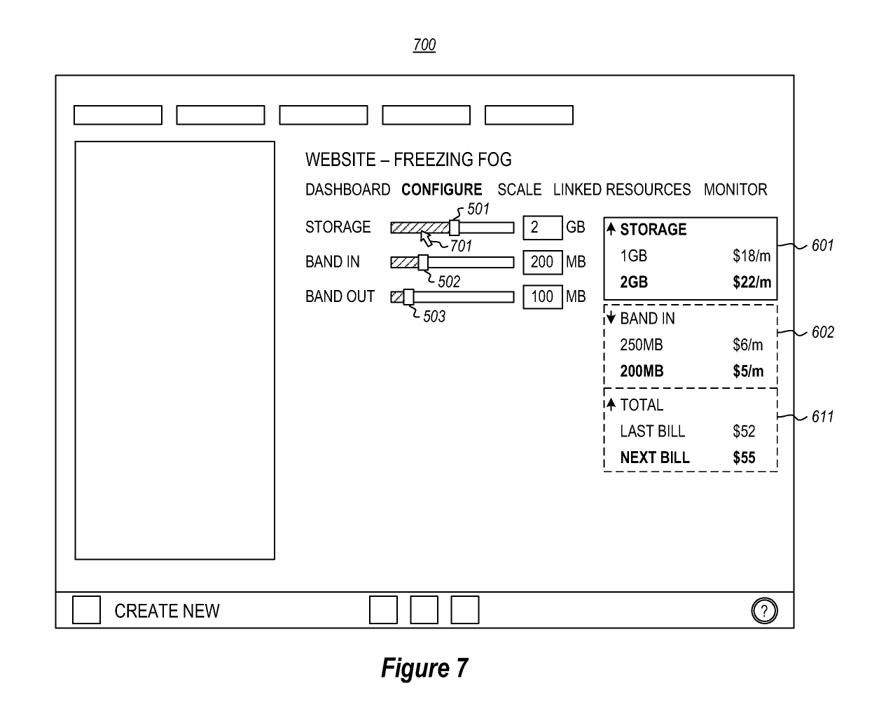

FIG. 7 illustrates a user interface context 700 that is similar to the user interface context 600 of FIG. 6. However, the user interface context 700 is shown as including an emphasis mechanism for emphasizing one of the first billing impact element 601 or 602 over the other billing impact element 602 or 601. For example, as represented in FIG. 7, since a pointer 701 hovers over the bill impacting control 501, the corresponding line item billing impact element 601 is visually emphasized in some way. If the pointer 701 were to hover over the bill impacting control 502, the corresponding line item billing impact element 602 would be visually emphasized instead.

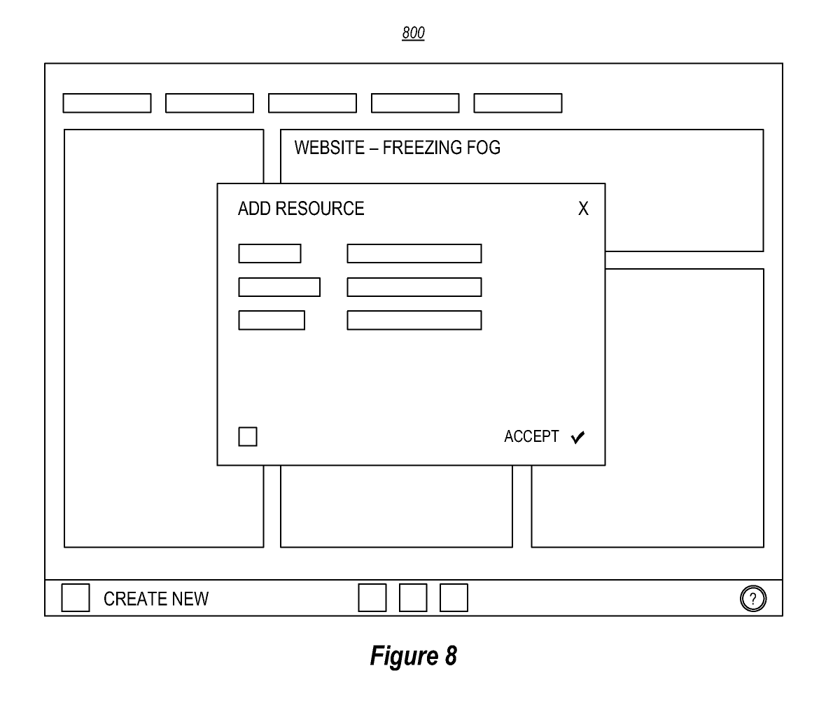

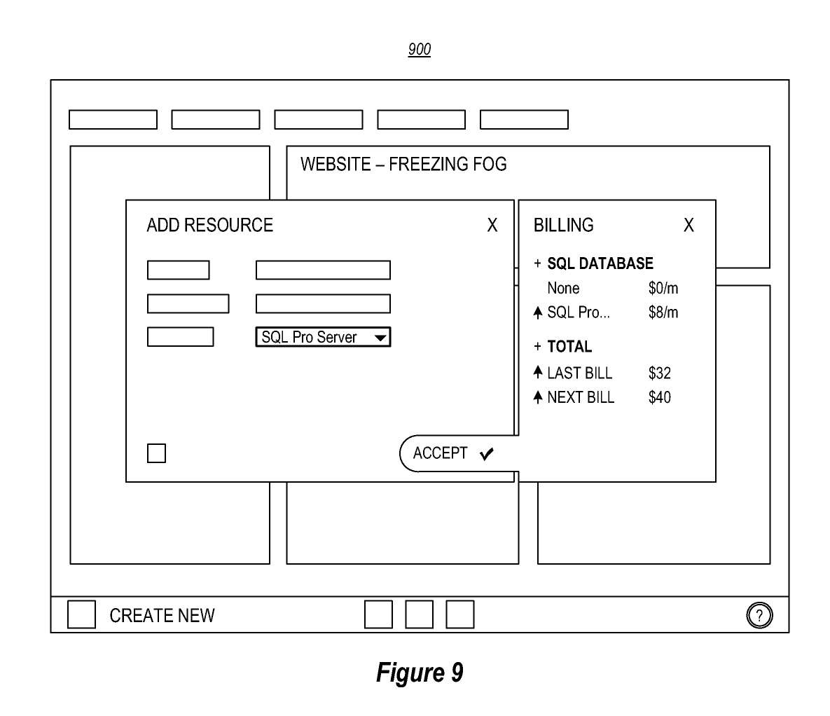

FIGS. 8 and 9 illustrates an example user interface comprises two user interface contexts. The user interface of FIGS. 8 and 9 is an example of the user interface 200 of FIG. 2. The user interface of FIGS. 8 and 9 will be referred to hereinafter as a “second example user interface”. The user interface is a dialog or wizard. Initially the user interface 800 appears without any billing impact being displayed. However, as represented in FIG. 9, as soon as an edit is made, a billing impact is shown.

In some embodiments, the billing impact element is displayed with some predetermined fixed relationship (e.g., to the right in FIGS. 5 through 9) of the bill impacting control, to allow for easy and predictable detection of the billing impact, and quick visual correlation with the control that caused the impact.

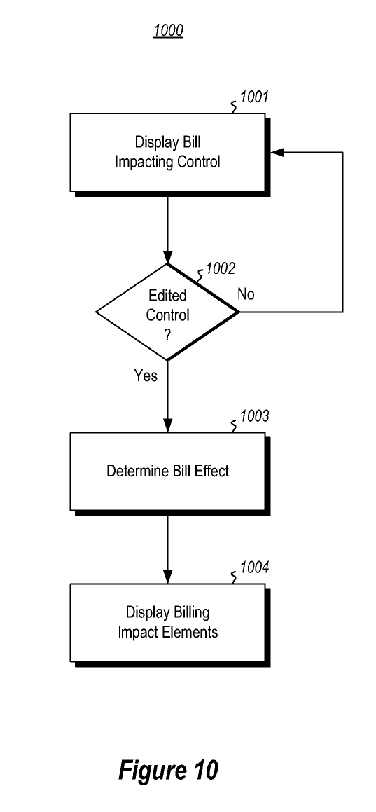

FIG. 10 illustrates a flowchart of a method 1000 for providing a user interface context within a user interface. First, the bill impacting control is displayed (act 1001). This is illustrated in FIG. 5 for the first example user interface, and FIG. 8 for the second example user interface. If there are no edits to the control that having billing impact (“No” in decision block 1002), then the method does not proceed. However, if there are edits to the control that have billing impact (“Yes” in decision block 1002), then the effect of the bill is determined (act 1003), and the corresponding billing impact control displayed (act 1004). This is illustrated in FIG. 6 for the first example user interface, and FIG. 9 for the second example user interface.

The billing impact avoids breaking the user's foci of attention by presenting billing information in a manner that is positionally within the current foci of attention. Rather than putting it on another page or separate user interface control, the billing impact is brought to the user's current activity context, making it easy for them to reference and understand. Billing impact information is presented adjacent to the user's primary focus. Thus, the billing impact information is easy to glance at, but does not block the user's current work. This is crucial for making the billing information helpful and not frustrating.

Billing information may be presented in a management free way. Users do not have to control when the billing impact shows up, where the billing impact is positioned or what the billing impact displays.

The billing information not only shows the user what they have added to their bill, but what changes they have made that reduce their bill. In addition, projections may be provided as to the long term impact of the billing changes so the user is able to see and adjust their changes based on a wider range of data.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable storage media having thereon computer-executable instructions that are structured such that, when executed by one or more processors of a computing system, cause the computing system to display a user interface on a display of the computing system, the user interface that includes at least one user interface context that comprises:
a bill impacting control that if edited and finalized has an impact on a bill; and
a billing impact element that is responsive to editing of the bill impacting control to visualize a change in the bill that would result from the editing if finalized, the billing impact element being displayed in the user interface context for at least a time after the editing occurs, and being readjustable to show further billing impact in response to further editing of the bill impacting control in the user interface context.

2. The computer program product in accordance with claim 1, wherein the bill impacting control is a first bill impacting control, and the billing impact element is a first billing impact element, the user interface context further comprising:
a second bill impacting control that if edited and finalized also has an impact on the bill; and
a second billing impact element that is responsive to editing of the second bill impacting control to visual a change in the bill that would result from the editing of the second bill impacting control if finalized, the second billing impact element being displayed in the user interface context for at least a time after the editing of the second bill impacting control occurs, and being readjustable to show further billing impact in response to further editing of the second bill impacting control in the user interface context.

3. The computer program product in accordance with claim 2, wherein the user interface context includes an emphasis mechanism for emphasizing one of the first billing impact element and the second billing impact element as compared to the other billing impact element.

4. The computer program product in accordance with claim 3, wherein the emphasis mechanism emphasizes the first billing impact element over the second billing impact element when a pointer element hovers over the first bill impacting control, and emphasizes the second billing impact element over the first billing impact element when the pointer element hovers over the second bill impacting control.

5. The computer program product in accordance with claim 2, wherein the first billing impact element and the second billing impact element are distinct elements in the user interface context.

6. The computer program product in accordance with claim 1, wherein the user interface context is a first user interface context, the bill impacting control is a first bill impacting control, and the billing impact element is a first billing impact element, the user interface further comprising a second user interface context that further comprises:
a second bill impacting control that if edited and finalized also has an impact on the bill; and
a second billing impact element that is responsive to editing of the second bill impacting control to visual a change in the bill that would result from the editing of the second bill impacting control if finalized, the second billing impact element being displayed in the second user interface context for at least a time after the editing of the second bill impacting control occurs, and being readjustable to show further billing impact in response to further editing of the second bill impacting control in the user interface context.

7. The computer program product in accordance with claim 6, wherein the first billing impact element of the first user interface context is the same as the second billing impact element of the second user interface context.

8. The computer program product in accordance with claim 1, wherein the bill impacting control adjusts an amount of resources available for a network service.

9. The computer program product in accordance with claim 8, wherein the adjusted amount of resources comprises an amount of storage available for the network service.

10. The computer program product in accordance with claim 8, wherein the adjusted amount of resources comprises an amount of bandwidth available for the network service.

11. The computer program product in accordance with claim 10, wherein the amount of bandwidth comprises an amount of input bandwidth available for the network service.

12. The computer program product in accordance with claim 10, wherein the amount of bandwidth comprises an amount of output bandwidth available for the network service.

13. The computer program product in accordance with claim 8, wherein the network service comprises a virtual machine service.

14. The computer program product in accordance with claim 8, wherein the network service comprises a web site hosting service.

15. The computer program product in accordance with claim 1, wherein the visualization of the change in the bill comprises a visualization of a change in a line item of the bill.

16. The computer program product in accordance with claim 1, wherein the visualization of the change in the bill comprises a visualization of a change in total of the bill.

17. The computer program product in accordance with claim 1, wherein the billing impact element appears when a first edit of the first bill impacting control occurs.

18. The computer program product in accordance with claim 1, wherein the user interface context appears in the user interface temporally before a final payment user interface context.

19. A method for providing a user interface context within a user interface, the method comprising:
an act of displaying a bill impacting control on a display of a computing system within the user interface context;
an act of detecting an editing of the bill impacting control that results from a user interacting with the computing system;
an act of determining an effect on a bill if the detected edit would be finalized; and
an act of displaying a billing impact element within the user interface element while the bill impacting control is still displayed in the user interface element and capable of being further adjusted in response to user input, the bill impact element altered in response to editing of the bill impacting control to show effects on a bill if the edits are finalized.

20. A computer program product comprising one or more computer-readable storage media having thereon computer-executable instructions that are structured such that, when executed by one or more processors of a computing system, cause the computing system to display a user interface on a display of the computing system, the user interface that includes at least one user interface context that comprises:
a first bill impacting control that if edited and finalized has an impact on a bill;
a second bill impacting control that if edited and finalized also has an impact on the bill;
a first billing impact element that is responsive to editing of the first bill impacting control to visualize a change in the bill that would result from the editing of the first bill impacting control if finalized; and
a second billing impact element that is responsive to editing of the second bill impacting control to visualize a change in the bill that would result from the editing of the second bill impacting control if finalized.
